(19) United States
(12) Patent Application Publication
(10) Pub. No.: US 2017/0149246 A1
(43) Pub. Date: May 25, 2017

(54) SYSTEM AND METHOD FOR DETERMINING THE SUITABILITY OF A PLURALITY OF ELECTRICAL PRODUCERS AND CONSUMERS WHICH ARE OPERATED IN A NETWORK AS A VIRTUAL POWER PLANT FOR SUPPLYING CONTROL POWER

(71) Applicant: LICHTBLICK SE, Hamburg (DE)

(72) Inventors: Stefan STORACE, Hamburg (DE); Jörg SCHLUTTER, Hamburg (DE); Martin RUMMENIE, Hamburg (DE); Henrik ANGENENDT, Buchholz in der Nordheide (DE)

(73) Assignee: LICHTBLICK SE, Hamburg (DE)

(21) Appl. No.: 15/321,606

(22) PCT Filed: Jul. 7, 2015
(86) PCT No.: PCT/EP2015/001378

§ 371 Date: Dec. 22, 2016

(30) Foreign Application Priority Data
Jul. 7, 2014 (DE) 10 2014 009 953.9

(51) Int. Cl. H02J 3/38; H02J 3/46; H02J 13/00

(52) U.S. Cl. CPC H02J 3/382; H02J 13/0062; H02J 3/46

(57) ABSTRACT

According to the invention, a system for the up-to-date determination of the suitability of technical units of a virtual power plant for supplying positive or negative control power, which
are spatially distributed as a virtual power plant to generate and/or store and/or consume electrical energy, and which
are connected to a power supply network for the purpose of supplying and/or removing electrical energy, and which
are connected via a communication link to a control center for the purpose of controlling their operation, is characterized by
a state signal generator at each of the technical units, which is configured to send, to the control center, in a regular time cycle and/or upon every state change in the respective technical unit, a state signal which signals the state change and/or contains information on the present state of the technical unit, and by
a computer in the control center which is configured to compare, according to the state signals and at least one scoring criterion, at least two of the technical units regarding their suitability for supplying positive or negative control power, as well as a corresponding method.

The invention relates to a system and a method for the up-to-date determination of the suitability of technical units of a virtual power plant for supplying positive or negative control power, particularly secondary control power. The technical units are operated as a virtual power plant. This means that they are spatially distributed in a decentralized manner to generate and/or store and/or consume electrical energy, and are connected to a power supply network to supply or remove electrical energy, and are connected to a control center via a communication link for the purpose of operation control. The invention can also be expediently used in other applications, such as in the production of minute reserve power.

As is known, power plants supply electrical energy to supply networks to establish an energy supply, wherein spatially distributed consumers are connected to said supply networks. In recent years, the degree of miniaturization and decentralization in this field has greatly increased: it is no longer the case that only central power plants which are independent of the location of energy consumption are operated. Rather there are more and more technical units being placed locally near consumers, which supply electrical energy to the network, on the one hand, and on the other hand remove electrical energy from the same. These can be, for example, solar cells which supply current to the consumers and then either store excess electricity locally in batteries or feed the same into the supply network—as well as local biogas plants or generators which are operated, by way of example, with diesel or gas and are also used to provide heat (for example, cogeneration units).

One way of operating these decentralized electrical units economically results from a form of organization which is often (and hereinafter) referred to as a “virtual power plant”: The intelligence of the virtual power plant controls the electrical units in the framework of existing degrees of freedom. In this approach, certain restrictions of the units must be taken into account (for example, ensuring the supply of heat, in the case of cogeneration units). Among other things, for this purpose, the electrical units are communicatively connected to a control center via a communication link, such as a data line. Electrical units in the present context may be (as already mentioned in part), by way of example, cogeneration units, photovoltaic systems, batteries (including mobile batteries installed, for example, in electrically-driven vehicles, e.g. connected for local charging.), heat pumps, storage heaters, wind turbines or emergency generators.

There is a disadvantage in the production of control power in the virtual power plant compared to a large power plant, which is the need to furnish control power in small units and in a spatially-distributed manner (or, in the case of negative control power, to divert the same into storage).

The problem addressed by the present invention is that of creating an efficient system and method for producing control power in a virtual power plant. This problem is addressed by a system having the features of claim 1 and by a method having the features of claim 2. Preferred embodiments are specified in the dependent claims.

The system and method according to the invention focus on the up-to-date determination of the suitability of technical units of a virtual power plant for supplying positive or negative control power. The technical units are spatially distributed to generate and/or store and/or consume electrical energy. The technical units are connected to a power supply network for the purpose of supplying or removing electrical energy. In order to control operation, the technical units are connected to a control center via a communication link.

According to the invention, in the method a state signal generator at each of the technical units sends, to the control center, in a regular time cycle (which can be configured—for example in a 5-minute time cycle) and/or upon every state change in the respective technical unit, a state signal which contains information on the present state of the technical unit (keep-alive signal) and/or signals the state change (trigger signal). A computer in the control center then compares at least two of the technical units regarding their suitability for supplying positive or negative control power, according to the state signals. It can then control the technical units according to the result of the comparison.

Accordingly, the system according to the invention has a state signal generator at each of the technical units, which is configured to send, to the control center, in a regular time cycle (which can be configured—for example in a 5-minute time cycle) and/or upon every state change in the respective technical unit (for example, between a production or consumption power value and zero, or between such a power value and another such power value), a state signal which signals the state change and/or contains information on the present state of the technical unit.

A computer in the control center is then configured to compare, according to the state signals, at least two of the technical units regarding their suitability for supplying positive or negative control power, and particularly to control the same according to the result of the comparison.

The comparison can take into account one or more evaluation criteria. When multiple evaluation criteria are considered, they can be incorporated with different strengths owing to a weighting.

The objective is therefore to determine which technical unit—for example of a CU—is “most suitable” for being switched on (and/or switched off). This method has been developed to have a system solution in the context of producing control power with small systems, which significantly increases the quality of the control power production, and in the process takes into account the particularities of such a virtual power plant. The data used for this purpose should always be as up-to-date as possible. It should be possible to modify adjustments for the scoring flexibly and with short notice (for example by manipulating database entries in a control system of the central control which are used for the configuration of the scoring), such that changes in the scoring (for example in the case of an undesired behavior) are possible without a software update.

These and other advantages and features of the invention will be further described in the following illustration of an embodiment of the invention, wherein:

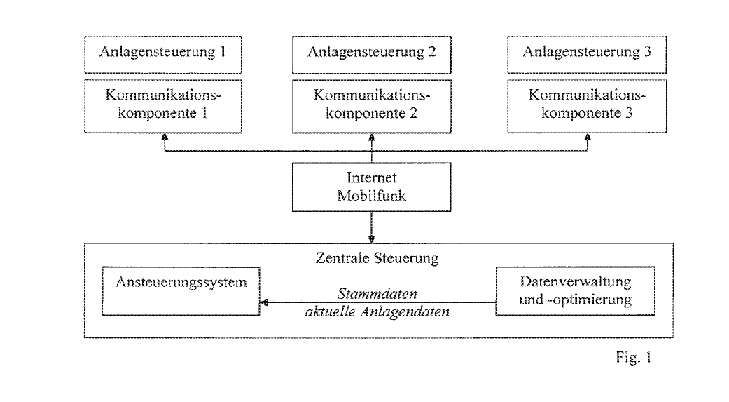

FIG. 1 shows a schematic of a system according to the invention in which the method according to the invention is carried out.

The embodiment according to FIG. 1 describes a system for the production of positive secondary control power by controlling a virtual power plant consisting of cogeneration units.

According to FIG. 1, the system control of each local electrical unit (e.g. CUs 1 to 3) relays to the control center, via the respective communication component, the following data required for the determination of the score values, by way of example:
time,
operating state,
meter data (e.g. work output of the CU in the last quarter hour),
malfunctions
sensor temperatures in the heat store

The communication component is the link between the local control system and the central control system. The data is sent both to the data management unit and to the control system.

The control system is used for the purpose of control, and also to determine the score values. The control system regularly retrieves updated data from the data management system.

The data management unit includes master and dynamic data of the systems. The optimization calculates in advance an optimized operation mode of the system, drawing on master and dynamic data in the process. Master data includes, for example, the heat store which is installed, and the capacity thereof. Dynamic data includes, for example, the operation states and heat loss over time.

The following components which are potentially incorporated can be used to determine the score value:

Keep-alive signal: So that the scoring always has current data, every technical unit of the virtual power plant sends a so-called “keep-alive signal”. This is sent (and can be configured), by way of example, every 5 minutes. Included in the signal are, by way of example, system state (on, ready, not ready, . . . ) and sensor temperatures of the heat stores. With the sensor temperatures, it is possible to calculate the storage state of a CU, as well as, for example, of a storage heater.

In the system, a control mechanism is installed which monitors the keep-alive signals, and reactivates the keep-alive connection of systems which have not transmitted for a longer period of time.

State data: If the cogeneration unit changes its state, it sends the state data in an event-controlled manner—that is, as a spontaneous signal transmission upon a particular event—to the computer in the control center.

The operation control can then receive a specified target power which must be maintained by the system. For this purpose, systems must either be allocated or “deallocated”. The basis for this is a delta value between target and actual values. In this case, the delta can be either greater than zero (switch on CU) or less than zero (switch off CU). If the delta is greater than zero, suitable systems from the switch-on scoring are used. In the event that a delta is less than zero, systems from the switch-off scoring are used.

The keep-alive monitoring activates the transmission of the keep-alive signals—preferably not for all systems at once, but in small, staggered intervals, such that a time-distributed and uniform arrival of the signals in the system is achieved. If new systems are added, or the system is restarted, the keep-alive monitoring should first enable the systems which have achieved a high scoring—that is, are best suited for switching on (or off).

The scoring according to the invention can be based on the analysis of different parameters of the technical units:

Duration of the last clock cycle: The duration of the last complete clock cycle is determined—i.e., the time interval between the most recent state immediately following an “on” state, and the “on” state immediately prior to this state.

Heat store state of the system: The heat store state of a system is transmitted via the keep-alive signals. These include temperature values from the memory. Using the knowledge of the locally installed storage volume, the maximum and minimum charging/discharging temperature, it is therefore possible to calculate the current storage state.

Calculation of the storage state deviation and the storage filling potential: The calculation of the storage state deviation and storage filling potential preferably takes into account the planned storage state profile, the actual storage state, and the storage potential.

The planned storage state profile is determined centrally. The actual storage state, which can be calculated from the temperature data of the sensor, can also be calculated centrally for a building. The storage state deviation, however, should be determined for each technical unit (e.g. a cogeneration unit). The time t which is then utilized in the calculation of the storage state deviation, is, for example, the time of the most current available temperatures. A negative storage state deviation (heat store state lower than expected) indicates, for example, that the CU is well-suited for the provision of additional power—that is, a negative storage state deviation leads to a generally higher switch-on score value.

The planned storage state profile is not likely in the form of a continuous function, but in the form of data series (planned storage state at certain times—for example, in quarter-hour segments). Therefore, the planned storage state at time t must, as a rule, be appropriately calculated from the two “neighboring” values.

Planned average heat demand: The planned average heat demand per cogeneration unit can be determined as follows: first, determining the current hour interval (e.g. 12:00-13:00); then, determining the planned average heat demand (after heat load prognosis): This value is then calculated as the average demand of this interval and the qualifying hours before (determined by the configuration “number of upstream hours for a heat demand determination”) and the qualifying hours thereafter (determined by the configuration “number of downstream hours for a heating demand determination”).

Determination of the connection status: The cogeneration units periodically transmit small data packets to the central system to inform the same of the current status and to maintain the communication. Upon receipt of this communication in the central system, the connection status of each cogeneration unit is set to “online”. If, on the other hand, there is no communication over a defined period of time, the cogeneration unit receives the connection status “offline”. A cogeneration unit likewise receives the status “offline” if the attempt of the central system to transmit an operating plan to a cogeneration unit fails.

Determination of the number of connection errors: The number of connection errors of each cogeneration unit during the previous hours can be determined. The number of hours is configurable. Connection errors can be:
direct errors during transmission of operating plans
timeouts during transmission of operating plans
timeouts during the keep-alive signal

Determination of the average availability: The central system attempts in regular intervals to communicate with the cogeneration units. Such a connection attempt is called a ping, and can be successful or not successful. The calculation of the average availability of a cogeneration unit is based on the following formula: average availability=number of successful pings in the previous 7 days/total number of pings of the previous 7 days.

The objective is therefore to determine, particularly in an up-to-date manner, whether and/or to what extent the technical units of a virtual power plant are suitable for providing a positive or negative secondary control power. In this regard, a ranking or scoring can be determined particularly in the computer of the control center for the suitability of the technical units, in particular in an up-to-date manner. Accordingly, the technical units can then be activated in order of suitability in case of a need to generate control energy, until the demand is met.

The scoring for the switching of power utilizes a distinction between hard and soft criteria. If a hard criterion is not met by a CU, for example, the result is that the CU is listed in the scoring as not available, and therefore cannot be switched on. CUs which meet all hard criteria will then be evaluated and categorized according to the soft criteria. In this case, a method shall be used which makes it possible to change the weighting of the criteria and the evaluation within the criteria without a software update, and rather by manipulation of database entries which are used to configure the scoring.

A score value is calculated for each CU, wherein a high score value basically means that the CU is currently well suited for switching to the provision of secondary control power. Moreover, via the qualifier “reserve”, it is possible to establish a configuration wherein certain ranges of values of a criterion lead to essentially excluding this CU. The CUs from the “reserve” pot are only considered if there is no switchable CU in the “main” pot. Within the reserve pot, the score value is decisive.

There can also be additional conditions for switching on:

The scoring sequentially selects CUs until the power of the selected CU has reached (or exceeded) the power difference. The attempt is always made to select the CU with the highest score value from the volume of CUs in the main pot (i.e., the CUs that are not marked with “reserve”); however, the conditions named below must be met. Only when all the CUs from the main pot have been checked, and the difference has not been reached, are the CUs from the reserve pot used. These in turn are considered in the order of their score value. The conditions for the switching must then also be respected. Conditions for the switching, which are examined during the activation, can be:
The system is at the current point in time and in the coming seconds (configurable) reserved for the provision of control power.
For the system, no operation is planned at the current point in time and within the coming seconds (configurable).
For the system, no blocking time is planned at the current point in time and within the coming seconds (configurable).
No system from the same building has been selected by the scoring within the recent seconds. The exact number of seconds can be configured.

The scoring can provide the following information as feedback:
lists of the systems which should be switched on,
a maximum running time per system (calculated as storage filling potential).

Once a system has been released for switching on, it is not kept in the scoring for switching on, but rather is moved to the scoring for shutting down.

The scoring for shutting down of power includes all CUs which have been released for switching on power. For switching off, a very simple scoring can be used: The CU is selected which was first released for switching on.

1. A system for the up-to-date determination of the suitability of technical units of a virtual power plant for supplying positive or negative control power, which
are spatially distributed as a virtual power plant to generate and/or store and/or consume electrical energy, and which
are connected to a power supply network for the purpose of supplying and/or removing electrical energy, and which
are connected via a communication link to a control center for the purpose of controlling their operation,
characterized by
a state signal generator at each of the technical units, which is configured to send, to the control center, in a regular time cycle and/or upon every state change in the respective technical unit, a state signal which signals the state change and/or contains information on the present state of the technical unit, and by
a computer in the control center which is configured to compare, according to the state signals and at least one scoring criterion, at least two of the technical units regarding their suitability for supplying positive or negative control power.

2. The system according to claim 1, characterized in that the computer in the control center is configured to compare, according to the state signals and multiple, weighted scoring criteria, at least two of the technical units regarding their suitability for supplying positive or negative control power.

3. The system according to claim 1, characterized in that the time cycle can be configured.

4. The system according to claim 1, characterized in that the state signal generator is configured to send, to the control center, a state signal which signals the state change and/or contains information on the present state of the technical unit upon every state change of the respective technical unit between a production or consumption power value and zero, or between such a power value and another such power value.

5. The system according to claim 1, characterized in that the computer in the control center is configured to compare, according to the state signals and at least one scoring criterion, at least two of the technical units regarding their suitability for supplying positive or negative control power, and to control the same according to the result of the comparison.

6. A method for the up-to-date determination of the suitability of technical units of a virtual power plant for supplying positive or negative control power, which
are spatially distributed as a virtual power plant to generate and/or store and/or consume electrical energy, and which
are connected to a power supply network for the purpose of supplying and/or removing electrical energy, and which
are connected via a communication link to a control center for the purpose of controlling their operation,
characterized in that
a state signal generator at each of the technical units sends, to the control center, in a regular time cycle and/or upon every state change in the respective technical unit, a state signal which signals the state change and/or contains information on the present state of the technical unit, and in that
a computer in the control center compares, according to the state signals and at least one scoring criterion, at least two of the technical units regarding their suitability for supplying positive or negative control power.

7. The method according to claim 6, characterized in that the computer in the control center compares, according to the state signals and multiple, weighted scoring criteria, at least two of the technical units regarding their suitability for supplying positive or negative control power.

8. The method according to claim 6, characterized in that the time cycle can be configured.

9. The method according to claim 6, characterized in that the state signal generator sends, to the control center, a state signal which signals the state change and/or contains information on the present state of the technical unit upon every state change of the respective technical unit between a production or consumption power value and zero, or between such a power value and another such power value.

10. The method according to claim 6, characterized in that the computer in the control center compares, according to the state signals and at least one scoring criteria, at least two of the technical units regarding their suitability for supplying positive or negative control power, and controls the same according to the result of the comparison.
